(19) United States
(12) Patent Application Publication
(10) Pub. No.: US 2023/0234592 A1
(43) Pub. Date: Jul. 27, 2023

(54) ELECTRIC VEHICLE FLEET OPTIMIZATION BASED ON DRIVER BEHAVIOR

(71) Applicant: Wireless Advanced Vehicle Electrification, LLC, Salt Lake City, UT (US)

(72) Inventors: Michael MASQUELIER, Park City, UT (US); Steve BALL, Sandy, UT (US); Arash RASTEH, Herriman, UT (US)

(21) Appl. No.: 17/585,083

(22) Filed: Jan. 26, 2022

(51) Int. Cl. B60W 40/09; B60W 20/20; G08G 1/00

(52) U.S. Cl. CPC B60W 40/09; B60W 20/20; G08G 1/20; B60W 2540/30

(57) ABSTRACT

Described herein are techniques for optimizing operation of a fleet of electric vehicles. In some embodiments, a fleet management platform may maintain, in relation to a plurality of drivers, driving behavior patterns determined to be associated with the each of the plurality of drivers. Upon receiving a request for optimization of at least one operation related to a fleet of electric vehicles, such techniques may comprise determining one or more factors associated with the optimization of the at least one operation, identifying a set of driving behavior patterns correlated to the one or more factors, and customizing the at least one operation based on the identified set of behavior patterns and the driving behavior patterns.

### BACKGROUND

As the world becomes more aware of the impact that the use of fossil fuels is having on the environment, the demand for environmentally friendly alternatives is increasing. In the realm of transportation, vehicles that are powered by fossil fuels are being replaced by alternatives including partially or fully electric vehicles. In some cases, entire fleets of vehicles, such as busses, are being replaced by electric vehicles. However, despite this increase in popularity, electric vehicles are subject to their own unique set of problems. For example, the range of an electric vehicle is often dependent upon the amount of charge that can be, or is, stored in a battery of that vehicle. This can be, and typically is, mitigated via the use of electric charging stations. In the case of an electric bus, such electric charging stations may be placed throughout a transit route that is traversed by the bus (e.g., at bus stops) to provide periodic recharging. Additionally, some electric vehicles may use recharging technology like regenerative braking to provide periodic recharging.

### SUMMARY

Techniques are provided herein for determining driving behaviors and optimizing management of a fleet of vehicles based on individual driving behavior patterns. In some embodiments, sensor data is received from various sensors installed throughout a vehicle during operation. Data patterns within that sensor data are then used to identify driving patterns to be associated with a particular driver of the vehicle. The driving patterns for a driver can then be used to identify efficiencies and/or inefficiencies associated with that driver. Those efficiencies/inefficiencies may be used in making fleet management decisions, which may include, by way of nonlimiting example, route planning, vehicle/driver pairing, scheduling, etc.

In one embodiment, a method is disclosed as being performed by a fleet management platform, the method comprising maintaining, in relation to a number of drivers, driving behavior patterns determined to be associated with the each of the number of drivers, receiving a request for optimization of at least one operation related to a fleet of electric vehicles, determining one or more factors associated with the optimization of the at least one operation, identifying a set of driving behavior patterns correlated to the one or more factors, and customizing the at least one operation based on the identified set of behavior patterns and the driving behavior patterns.

An embodiment is directed to a computing system comprising a processor; and a memory including instructions that, when executed with the processor, cause the computing device to, at least: maintain, in relation to a number of drivers, driving behavior patterns determined to be associated with the each of the number of drivers, receive a request for optimization of at least one operation related to a fleet of electric vehicles, determine one or more factors associated with the optimization of the at least one operation, identify a set of driving behavior patterns correlated to the one or more factors, and customize the at least one operation based on the identified set of behavior patterns and the driving behavior patterns.

An embodiment is directed to a non-transitory computer-readable media collectively storing computer-executable instructions that upon execution cause one or more computing devices to collectively perform acts comprising maintaining, in relation to a number of drivers, driving behavior patterns determined to be associated with the each of the number of drivers, receiving a request for optimization of at least one operation related to a fleet of electric vehicles, determining one or more factors associated with the optimization of the at least one operation, identifying a set of driving behavior patterns correlated to the one or more factors, and customizing the at least one operation based on the identified set of behavior patterns and the driving behavior patterns.

Embodiments of the disclosure provide numerous advantages over conventional systems. For example, the system disclosed herein enables operations of a fleet of electric vehicles to be managed in a way that optimizes resources. For example, in a scenario in which drivers are to be assigned to transit routes, the system may optimize battery usage/charging by assigning drivers that have a tendency to use regenerative braking functions in the electric vehicle to routes that have more traffic lights. This can result in more energy being recaptured during the braking process and consequently extend the range of the electric vehicle.

Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example computing environment in which operations of a fleet of electric vehicles may be optimized based on individual driving behaviors in accordance with some embodiments;

FIG. 2 illustrates a block diagram showing various components of an example system architecture that supports optimization of electric vehicle fleet management in accordance with some embodiments;

FIG. 3 illustrates a flow chart of an example process by which behavior data is associated with a driver in accordance with at least some embodiments;

FIG. 4 illustrates a flow chart of an example process by which operations for a fleet of electric vehicles is optimized in accordance with at least some embodiments; and

FIG. 5 depicts a flow chart of an example process for optimizing fleet operations in accordance with at least some embodiments.

### DETAILED DESCRIPTION

This disclosure is directed towards a system that determines behaviors or other characteristics associated with particular drivers or groups of drivers and optimizes management of one or more vehicles of a fleet of electrical vehicles based at least in part on identified patterns. For example, sensor data received from one or more of the vehicles in the fleet of electric vehicles may be used, along with driver identifying information, to determine driving behavior patterns to be associated with particular drivers. Once such driving behavior patterns have been determined, operations of one or more vehicles of a fleet of electric vehicles may be optimized based on those driving behavior patterns.

Optimization of operations of a fleet of vehicles may take many forms. By way of example, the system may provide techniques for optimizing assignments of drivers to transit routes for the fleet of vehicles. In this example, drivers may be assigned to transit routes in a manner that optimally allows for each electric vehicle to complete and/or progress its respective route. By way of further example, such driver assignment may be made based on the driver's propensity toward the use of regenerative braking techniques or based on the driver's tendency to stop for sufficient time over vehicle charging plates. In another example, the system may provide techniques for identifying training opportunities for drivers based on inefficiencies identified in their respective driving behavior patterns. In this example, driver training may be assigned in a manner that is determined to result in optimization of driver behavior patterns. By way of yet another example, computer executable instructions (i.e., software code) provisioned onto the electric vehicle may be updated to suit a driver or a group of drivers. For example, based on the drivers' tendency to use regenerative braking, the software for the electric vehicle may be updated (e.g., via an over-the-air (OTA) update) such that a regenerative braking profile is updated from conservative to aggressive or vice versa.

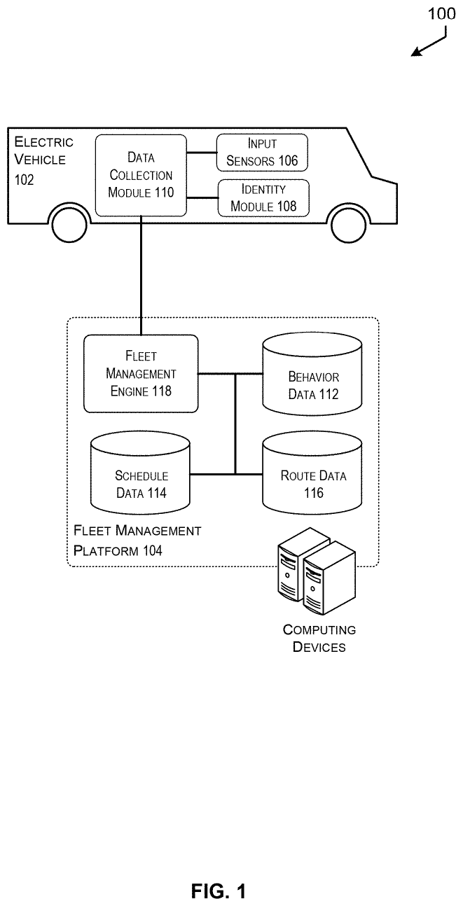

FIG. 1 illustrates a computing environment 100 in which operations of a fleet of electric vehicles may be optimized based on individual driving behaviors. In some embodiments, one or more electric vehicle 102 is in communication with a fleet management platform 104. In some embodiments, the electric vehicle is in continuous or semi-continuous communication with the fleet management platform via a wireless communication channel. In some embodiments, the electric vehicle may establish communication with the fleet management platform upon arriving at particular access points (e.g., recharging stations and/or bus stops).

An electric vehicle 102 may include any suitable mode of transportation that operates primarily using electric current. In some embodiments, electric current available to a particular electric vehicle may be limited based on a capacity of a battery or other electric storage medium. In some embodiments, the charge on a battery of the electric vehicle may be restored at least partially throughout a vehicle's operation. For example, in the case that the electric vehicle is a bus that makes stops along a route, the battery of the electric vehicle may be recharged at least partially each time that the bus positions itself over a charging pad located at one of the bus stops. In another example, the electric vehicle may be configured to perform regenerative braking each time that the vehicle slows down or stops, which is an energy recovery mechanism that slows down a moving vehicle or object by converting its kinetic energy into a form that can be either used immediately or stored until needed (in this case, battery charge).

In some embodiments, the electric vehicle may include one or more input sensors 106 configured to obtain information about an aspect of the vehicle. For example, input sensors may be installed within, or alongside, the vehicle brake pedal to determine how much pressure a driver applies to the brake pedal as well as for how long such pressure is applied. In another example, an input sensor may be installed within, or alongside, the vehicle steering wheel to collect and provide information on a how the steering wheel is rotated during turns.

Additionally, the electric vehicle may include an identity module 108 that is configured to determine an identity of a current operator of the electric vehicle. In some cases, the identity module may make such a determination based on input received from the operator. For example, the operator may input an operator identifier or other unique means of identifying a particular operator into an input field of a user interface. In another example, the operator may scan, or otherwise present, his or her badge at a badge reader device installed within the electric vehicle. In some embodiments, a current operator of the electric vehicle may be identified based on schedule information for the electric vehicle. In some cases, such schedule information may be maintained by the fleet management platform.

Data obtained from the input sensors and/or identity module may be provided to a data collection module 110 to be processed and provided to the fleet management platform. In some embodiments, behavior data may be identified based on the sensor data received from the input sensors. In some embodiments, sensor data received from a particular input sensor may be compared to sensor data received under similar circumstances. For example, sensor data received from a sensor installed in communication with a steering wheel that is collected at a particular location may be compared to sensor data received in relation to steering wheel information received from other vehicles/drivers at that particular location. In this example, variances between the compared steering wheel data may be used to determine steering behavior for that driver.

The fleet management platform 104 may include any computing device or combination of computing devices configured to perform at least a portion of the functionality described herein. Fleet management platform may be composed of one or more general purpose computers, specialized server computers (including, by way of example, PC (personal computer) servers, UNIX™ servers, mid-range servers, mainframe computers, rack-mounted servers, etc.), server farms, server clusters, or any other appropriate arrangement and/or combination. Fleet management platform can include one or more virtual machines running virtual operating systems, or other computing architectures involving virtualization such as one or more flexible pools of logical storage devices that can be virtualized to maintain virtual storage devices for the computer.

The fleet management platform 104 may be configured to optimize fleet management activities using behavior data for a driver. In some embodiments, the fleet management platform may be configured to maintain behavior data 112 for each of a number of drivers. The behavior data may include information that has been aggregated about trends or patterns identified in relation to behaviors displayed by one or more particular drivers. Additionally, the fleet management platform may be configured to maintain schedule data 114 that includes an indication of time periods during which one or more drivers is available, as well as route data 116 that includes information about route scheduling for vehicles.

Within a fleet management platform, fleet management activities may be optimized by a fleet management engine 118 that is configured to make fleet management determinations using the behavior data received by the fleet management platform. In some embodiments, this may comprise assigning drivers to routes in a manner that minimizes battery usage or maximizes charging of the battery during operation of a vehicle. In some embodiments, this may comprise recommending driver training based on identified driving behavior patterns associated with one or more drivers. In some embodiments, this may comprise providing instructions to the electric vehicle to negate certain driver behaviors. For example, upon making a determination that a particular driver has a tendency to apply an inordinately high amount of pressure to brake pads, the fleet management platform may provide instructions to an electric vehicle being operated by the driver to cause that electric vehicle to decrease the sensitivity of the brake pads (e.g., by reducing the pressure in a hydraulic brake line).

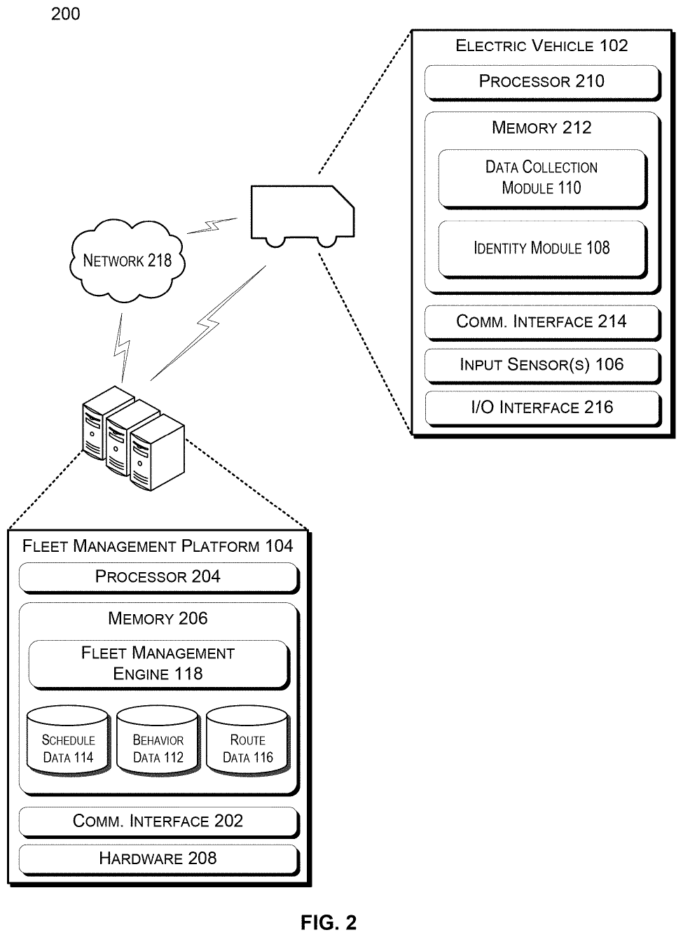

FIG. 2 illustrates a block diagram showing various components of a system architecture that supports optimization of electric vehicle fleet management in accordance with some embodiments. The system architecture may include a fleet management platform 104 may be in communication with one or more electric vehicles 102.

As noted above, a fleet management platform 104 can include any computing device configured to perform at least a portion of the operations described herein. The fleet management platform 104 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The fleet management platform 104 can include one or more virtual machines running virtual operating systems, or other computing architectures involving virtualization such as one or more flexible pools of logical storage devices that can be virtualized to maintain virtual storage devices for the computer. For example, the fleet management platform 104 may include virtual computing devices in the form of virtual machines or software containers that are hosted in a cloud.

The fleet management platform 104 may include a communication interface 202, one or more processors 204, memory 206, and hardware 208. The communication interface 202 may include wireless and/or wired communication components that enable the fleet management platform 104 to transmit data to and receive data from other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the fleet management platform 104 may implement functionality that includes one or more software modules and data stores. Such software modules may include routines, program instructions, objects, and/or data structures that are executed by the processors 204 to perform particular tasks or implement particular data types. More particularly, the memory 206 may include at least a module that is configured to manage operations of one or more vehicles in a fleet of electric vehicles. Additionally, the fleet management platform may include a number of data stores that include information that may be used by the fleet management platform to optimize operations of the fleet. For example, the fleet management platform may include a database of information on driver schedules (e.g., schedule data 114), a database of information on learned driver behavior data (e.g., behavior data 112), and/or a database of information on routes to be traversed by one or more electric vehicles (e.g., route data 116).

A fleet management engine 118 may be configured to, in conjunction with the processor 204, perform optimization of fleet operations based on driver behavior information stored by the fleet management platform. In some embodiments, drivers may be assigned to routes based on their likelihood for engaging in certain driving behaviors. For example, drivers that are less likely to engage regenerative braking capabilities of the electric vehicle may be assigned routes that have fewer stops than are assigned to drivers that are more likely to engage regenerative braking capabilities of the electric vehicle. In this example, the route assignment is optimized in that the recharging of the vehicles is maximized during route traversal allowing for increased battery usage efficiency as well as traversal over longer distances.

A noted elsewhere, an electric vehicle 102 may comprise any suitable vehicle that is primarily powered using electrical current. In addition to including various components required to enable transit, the electric vehicle includes one or more processors 210, a memory 212, a communication interface 214, one or more input sensors 106, and an input/output interface 216.

The one or more processors 210 and the memory 212 of the fleet management platform 104 may implement functionality that includes one or more software modules and data stores. Such software modules may include routines, program instructions, objects, and/or data structures that are executed by the processors 210 to execute one or more functions of the electric vehicle. More particularly, the memory 212 may include at least a module that is configured to facilitate the collection of user driving data (e.g., data collection module 110) and a module for determining an identity of a current driver of the electric vehicle to be associated with the identified driving behavior.

An identity module 108 may be configured to, in conjunction with the processor 210, determine an identity of the current driver of the electric vehicle. In some embodiments, the driver may enter his or her identifier into an input device (e.g., via I/O Interface 216) upon entering, or upon starting up, the electric vehicle. In some embodiments, the driver may be identified by virtue of a wireless signal received at a wireless receiver installed on the electric vehicle. In some cases, the driver scans a badge, such as a Radio Frequency Identification (RFID) badge in front of a badge reader. In some embodiments, the driver may be in possession of a transmitter that is configured to transmit an identifier associated with the driver to a wireless receiver in proximity to the driver. In some embodiments, schedule data may be provided to the electric vehicle by the fleet management platform. In these embodiments, a driver of the electric vehicle may be identified based on a comparison of the schedule data to a current time.

A data collection module 110 may be configured to, in conjunction with the processor 210, determine driver behavior to be associated with the current driver of the electric vehicle. The data collection module may receive input sensor data from a number of different input sensors installed within the vehicle, each of which may be in communication with a component of the electric vehicle (e.g., brake pad, gas pedal, steering wheel, et.). The input sensor data may include information about the activation or use of the component with which it is in communication. In some embodiments, the input sensor data may indicate a degree or strength to which a component has been activated. The data collection module may record times and/or locations at which various sensor readings are received during the operation of an electric vehicle.

In some embodiments, one or more components of the electric vehicle may be configured to execute instructions received from the fleet management platform. In these embodiments, the electric vehicle may receive instructions that, when executed, cause one or more components of the electrical vehicle to be adjusted or to perform an operation. For example, the electric vehicle may receive instructions that, when executed, cause a sensitivity of the vehicle's brake pad or gas pedal to be adjusted (e.g., by adjusting the pressure of a hydraulic line). In another example, a sensitivity of the steering wheel may be adjusted so that a turning radius of the electric vehicle is either increased or decreased for an amount of rotation applied to the steering wheel.

As noted elsewhere, the fleet management platform may be configured to communicate with one or more electric vehicle. Such communication may be enabled via any suitable wired or wireless communication means. In some embodiments, the fleet management platform may be configured to communicate with the electric vehicle directly via a short-range wireless communication means. In some embodiments, the fleet management platform may be configured to establish communication with the electric vehicle over a network 218.

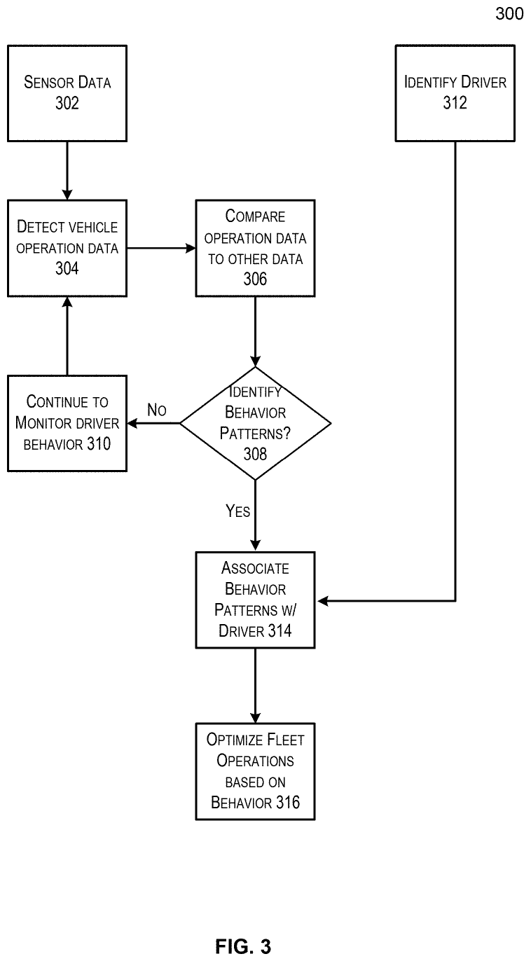

FIG. 3 illustrates a flow chart process by which behavior data is associated with a driver in accordance with at least some embodiments. The process 300 involves a number of interactions between various components of the computing environment described with respect to FIG. 1.

At 302, the process 300 comprises receiving sensor data from a number of input sensors installed within an electric vehicle. In some cases, one or more of the input sensors may be in communication with components of the electric vehicle. In these cases, the input sensor data may be received each time that the respective component is activated. In some cases, one or more of the input sensors may collect information about the electric vehicle and/or an environment in which the electric vehicle is located. For example, input sensors may include a Global Positioning System (GPS) device that collects location data for the electric vehicle, a thermometer that collects temperature information, a magnetometer that collects orientation information, or any other suitable sensor device. In some embodiments, the sensor data may be received continuously from one or more of the input sensors installed in the vehicle.

At 304, the process 300 comprises detecting driver behavior based on the received sensor data. In some embodiments, driver behavior may be detected upon interpreting the received sensor data. For example, upon detecting, such as from GPS sensor data, that the vehicle's location is changing, a determination may be made that the vehicle is in transit. In this example, a speed and direction of the vehicle may also be determined. In another example, upon receiving information from an input sensor in communication with a brake pad included in the vehicle, a determination may be made that the vehicle is braking. Upon detecting vehicle operations as interpreted from the received input sensor data, those vehicle operations may each be associated with times and locations as detected from location data that is also received at the time that the sensor data is received.

At 306, the process 300 comprises comparing the detected operation data against other operation data to identify variances and/or similarities between that operation data. In some embodiments, the operation data may be compared to operation data received from either the same or a different vehicle. In some embodiments, operation data associated with a particular location may be compared to operation data that is associated with the same location at different times. In some embodiments, the operation data may be compared to operation data identified with respect to the same vehicle at different locations.

In some embodiments, a baseline operation data may be generated in association with particular locations. Such a baseline operation data may be generated by aggregating operation data received at different times and/or from different vehicles. In some embodiments, baseline operation data may be generated for each of a number of locations by aggregating operation data associated with the respective locations of the number of locations. Such operation data may comprise operation data received determined with respect to either the same vehicle or different vehicles. A baseline operation generated for a location may include any suitable indication of operations that are typical at the location. For example, the baseline operation data may include an indication of a speed at which vehicles typically move at the location, braking patterns typically used at the location, acceleration patterns typically used at the location, or any other suitable operation data.

At 308, the process 300 may comprise identifying behavior patterns for a driver based on the comparison at block 306. In some embodiments, driving behavior patterns may be determined based on a degree to which the operation data determined from the received sensor data matches the operation data to which it is compared (e.g., other operation data or a baseline operation data). Such driving behavior patterns may comprise an indication of the current driver's actions in relation to typical driver actions. For example, driving behavior patterns may include an indication of the current driver's speed in operating the vehicle in relation to typical drivers' speed. In another example, driving behavior patterns may include an indication of the current driver's use of features (e.g., regenerative braking, etc.) in relation to typical drivers' use of features. In some embodiments, driver behavior patterns may be determined based on variances detected between the detected operation data and the operation data to which it has been compared. For example, a driver behavior pattern may be detected that indicates that the driver is driving, or has a tendency to drive, at a relatively high speed upon determining that the current operation data indicates a speed of travel that is higher than that of a baseline operation data.

In some cases, driver behavior patterns may only be identified upon detecting a variance between the compared operation data. Upon failing to identify driver behavior patterns to be associated with a driver (e.g., “No” from decision block 308), the process 300 comprises continuing to monitor for driver behavior patterns at 310.

At 312, the process 300 comprises identifying a current driver of the electric vehicle. In some embodiments, a fleet management platform may receive an indication of a driver identification from the electric vehicle for which the driver is to be identified. In some embodiments, the fleet management platform may determine an identity of the driver of the electric vehicle based on scheduling data maintained in relation to drivers, electric vehicles, and/or routes.

Upon identifying behavior patterns to be associated with a driver (e.g., “Yes” from decision block 308), the process 300 comprises storing an association between the identified behavior patterns and the current driver. In some embodiments, the driving behavior patterns associated with the current driver may be aggregated into stored driving behavior patterns for that user. For example, upon detecting that the driver is currently traveling at a speed that is higher than a typical speed for other drivers, a speeding behavior pattern may be identified and aggregated into the driver's behavior patterns. The aggregated behavior patterns for a driver in this example may indicate a propensity of that driver to speed.

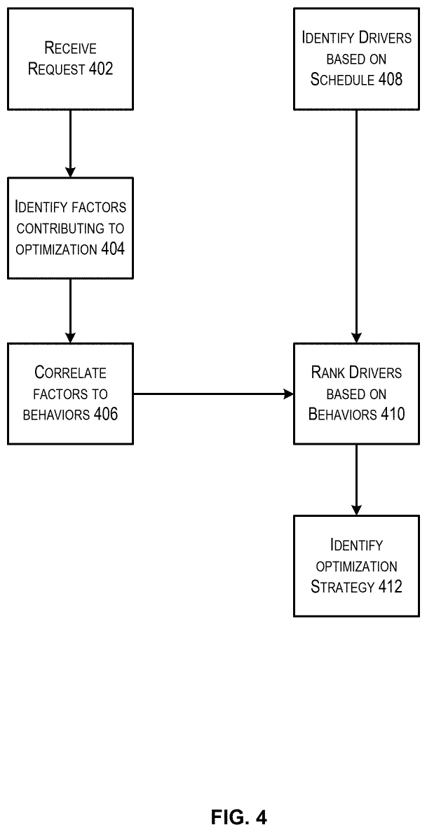

At 316, the process 300 comprises optimizing operations of a fleet of electric vehicles based on the behavior patterns. Processes for optimizing operations of a fleet of electric vehicles are described in greater detail with respect to FIG. 4 below.

FIG. 4 illustrates a flow chart process by which operations for a fleet of electric vehicles is optimized in accordance with at least some embodiments. The process 400 involves a number of interactions between various components of the computing environment described with respect to FIG. 1.

At 402 of the process 400, a request may be received to provide optimized management of a fleet of electric vehicles. Such a request may comprise any suitable request for operations associated with the fleet of vehicles. In one example, a request may be received to have drivers assigned to routes/vehicles. In another example, a request may be received to determine a need for training of drivers.

At 404, the process 400 comprises identifying factors that contribute to optimization of fleet operations. In some embodiments, the fleet management platform may maintain an indication of one or more factors associated with optimization of a particular operation. For example, optimization of battery usage during operation of an electric vehicle along a particular route may depend upon a length of the route, a number of stops on the route, an age or condition of a battery installed in the electric vehicle, etc.

At 406, the process 400 comprises correlating the identified factors to one or more driving behavior patterns. In some cases, the fleet management platform may maintain a mapping of factors to driving behaviors that influence those factors as well as an indication as to how those driving behaviors affect each of the factors. For example, as noted above, optimization of battery usage during operation of an electric vehicle along a particular route may depend upon a length of the route, a number of stops on the route, an age or condition of a battery installed in the electric vehicle. In this example, a determination may be made that a driver's tendency to utilize regenerative braking techniques affects battery usage efficiency by a degree that corresponds to the number of stops on the route. In this example, a higher tendency to utilize regenerative braking (e.g., the driving behavior) may be determined to result in higher battery usage efficiency for routes that have a higher number of stops. In some cases, driving behaviors may be assigned a weight value based on their correlation to optimization of certain factors.

At 408, the process 400 comprises identifying driver availability based on maintained schedule data. In some cases, availability data may be stored in relation to a number of drivers that indicates periods of time during which each of the respective driver is available. In some embodiments, the availability data may further indicate a region or area within which each of the respective drivers operate. In some embodiments, the availability data may indicate one or more licenses maintained by a respective driver and/or an indication of vehicle types that may be operated by the driver.

At 410, the process 400 comprises ranking driver assignment based on the driving behaviors associated with one or more drivers and based on driver availability. For example, given a set of vehicle routes, each of the drivers identified as being available may be ranked in accordance with the driver's suitability for each of the routes. Such suitability may be determined based on the behavior data associated with that driver and its correlation with factors determined to be associated with optimization of fleet operations. In some embodiments, generating a ranking may comprise using an algorithm to include weighted values (e.g., the weighted values associated with the behaviors at 406) for the drivers.

At 412, the process 400 comprises identifying an optimization strategy in response to the received request. In some embodiments, an optimization strategy may be generated by matching drivers to one or more operations (e.g., routes, vehicles, etc.). In some embodiments, one or more operations may be ranked in order of optimization difficulty and then assigned a driver based on that order. For example, where the optimization strategy involves the assignment of drivers to transit routes in order to optimize battery usage across the fleet, transit routes may be ranked in order of typical battery usage. In some embodiments, this may be done by assigning a weighted value to factors that affect battery usage in either a positive or negative manner. For example, the length of the transit route may correlate to battery usage in a positive manner (e.g., longer routes result in more battery usage) whereas the number of bus stops that include recharging plates along the route correlate to battery usage in a negative manner (e.g., since the battery will be recharged at each of those stops). In the provided example, each of the ranked transit routes may be assigned a driver in the order of their rank. Particularly, the transit routes determined to result in the highest battery usage may be assigned a driver best suited to that route. This is then repeated for the transit routes determined to result in the second highest battery usage and so on. Once generated, the optimization strategy may be provided to an entity from which the request for optimization was received.

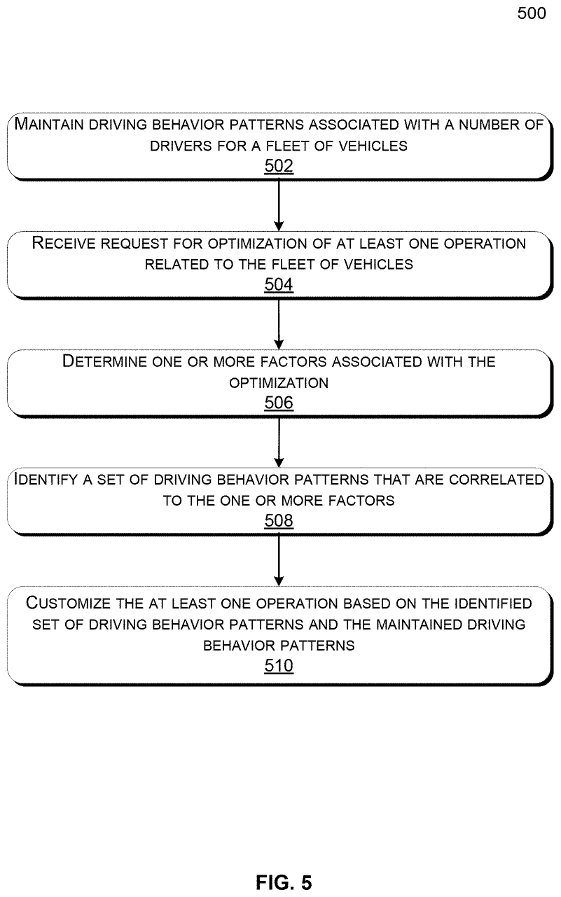

FIG. 5 depicts a flow diagram showing an example process flow 500 for optimizing fleet operations in accordance with embodiments. The process 500 may be performed by a computing device that is configured to generate and provide a product strategy for a product. For example, the process 500 may be performed by a fleet management platform, such as the fleet management platform 104 described with respect to FIG. 1 above.

At 502, the process 500 comprises maintaining driving behavior patterns associated with a number of drivers for a fleet of electric vehicles. In some embodiments, the driving behavior patterns are determined to be associated with the number of drivers based at least in part on sensor data received from one or more electric vehicles in the fleet of electric vehicles. In the above embodiments, at least a portion of the sensor data may be received from input sensors in communication with components of the one or more electric vehicles in the fleet of electric vehicles. In some cases, the driving behavior patterns are associated with a driver of the number of drivers based on a driver identifier received by the one or more electric vehicles in the fleet of electric vehicles. In other cases, the driving behavior patterns are associated with a driver of the number of drivers based on scheduled route information for the one or more electric vehicles in the fleet of electric vehicles.

In some embodiments, sensor data received from the various sensors installed within an electric vehicle may be associated with a location of the vehicle at the time that the sensor data is collected. For example, in addition to receiving sensor data from an electric vehicle, the fleet management platform may also receive location data (e.g., GPS data) from that electric vehicle. The received sensor data may then be stored in association with that location data as well as an indication of the driver. In some embodiments, to identify driving behavior patterns from the sensor data, that sensor data may be compared to other sensor data. Particularly, the sensor data may be compared to other sensor data associated with the same location. In some cases, this may be sensor data received from other electric vehicles and/or in relation to other drivers that was collected from the same location.

At 504, the process 500 comprises receiving a request for optimization of at least one operation related to the fleet of vehicles. In some embodiments, the request for optimization of at least one operation related to the fleet of electric vehicles comprises a request to assign drivers to transit routes that are serviced by the fleet of electric vehicles. In some embodiments, the request for optimization of at least one operation related to the fleet of electric vehicles comprises a request to identify training to be performed by at least a portion of the number of drivers.

At 506, the process 500 comprises determining one or more factors associated with the optimization to be performed. In some embodiments, such factors may comprise characteristics of, or details related to, the operation to be optimized. For example, where the optimization of the at least one operation related to a fleet of electric vehicles comprises optimization of battery usage during operation of the vehicles, such factors may include a length of a transit route that is traveled by the vehicle, a number of stops (either bus stops or stops at traffic lights), an age/condition of the battery currently installed in the vehicle, route timing conditions (e.g., a maximum route completion time), or any other suitable factor. In some embodiments, such factors may include characteristics that are external to the operation to be optimized. In the example given above, such factors may include weather conditions (e.g., an external temperature or a speed and direction of wind), road conditions (e.g., blockage due to construction or congestion (i.e., traffic)), traffic light timing, or any other suitable factor.

At 508, the process 500 comprises identifying a set of driving behavior patterns that are correlated to the one or more factors. Driving behavior patterns may be quantified using any suitable technique. For example, weighted values may be generated based upon identified driving behavior patterns. Factors may be either positively or negatively correlated to one or more behavior patterns. In some embodiments, identifying the set of driving behavior patterns correlated to the one or more factors comprises referencing a maintained mapping of driving behavior patterns to factors. For example, the fleet management platform may maintain an algorithm or set of algorithms that define a relationship between various factors and driving behavior patterns.

In some cases, a relationship between optimization of an operation and one or more driving behavior may be generated using one or more machine learning techniques. For example, in some cases a machine learning model may be provided with driving behaviors as inputs as well as operation data as outputs. In this example, the machine learning model may be configured to identify the relationship between the provided inputs and outputs. Such a relationship may be captured via a trained machine learning model that may then be used to optimize the relevant fleet management operations.

At 510, the process 500 comprises performing the optimization by customizing the at least one operation based on the identified set of driving behavior patterns in comparison to the driving behavior patterns maintained in association with the number of drivers. In some embodiments, the fleet management platform also maintains schedule data that includes information on the availability of each of the number of drivers. In these embodiments, the operation customization may also be generated based at least in part on that schedule data.

In some embodiments, the customization of the at least one operation is generated by ranking each driver with respect to the at least one operation. In these embodiments, such a ranking indicates a suitability of the driver with respect to the at least one operation. For example, where the operation comprises a transit route to which a driver is to be assigned, each of the drivers that are available for the transit route may be ranked based on that driver's driving behavior patterns. In this example, the driver with the highest ranking for the transit route may be assigned to that transit route.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method for electric vehicle fleet scheduling comprising:
maintaining, in relation to a plurality of drivers, driving behavior patterns determined to be associated with the each of the plurality of drivers;
receiving a request for determination of at least one operation related to a fleet of electric vehicles;
determining one or more factors associated with the optimization of the at least one operation;
identifying a set of driving behavior patterns correlated to the one or more factors; and
customizing the at least one operation based on the identified set of behavior patterns and the driving behavior patterns.

2. The method of claim 1, wherein the at least one operation is also customized based at least in part on schedule data associated with the plurality of drivers.

3. The method of claim 1, wherein the driving behavior patterns are determined to be associated with the plurality of drivers based at least in part on sensor data received from one or more electric vehicles in the fleet of electric vehicles.

4. The method of claim 3, wherein at least a portion of the sensor data is received from input sensors in communication with components of the one or more electric vehicles in the fleet of electric vehicles.

5. The method of claim 3, wherein the driving behavior patterns are associated with a driver of the plurality of drivers based on a driver identifier received by the one or more electric vehicles in the fleet of electric vehicles.

6. The method of claim 3, wherein the driving behavior patterns are associated with a driver of the plurality of drivers based on scheduled route information for the one or more electric vehicles in the fleet of electric vehicles.

7. The method of claim 3, wherein the sensor data is associated with a location of the one or more electric vehicles at a time that the sensor data is obtained.

8. The method of claim 7, wherein the driving behavior patterns are determined based on a comparison of the sensor data to other sensor data obtained at the location.

9. The method of claim 8, wherein the driving behavior patterns are determined from variances identified from the comparison.

10. A computing system comprising:
a processor; and
a memory including instructions that, when executed with the processor, cause the computing device to, at least:
maintain, in relation to a plurality of drivers, driving behavior patterns determined to be associated with the each of the plurality of drivers;
receive a request for determination of at least one operation related to a fleet of electric vehicles;
determine one or more factors associated with the optimization of the at least one operation;
identify a set of driving behavior patterns correlated to the one or more factors; and
customize the at least one operation based on the identified set of behavior patterns and the driving behavior patterns.

11. The computing system of claim 10, wherein the one or more factors comprise characteristics of the operation to be optimized.

12. The computing system of claim 11, wherein the operation to be optimized comprises a transit route, and the one or more factors comprise at least one of a length of the transit route, a plurality of stops along the transit route, a condition of a battery used on the transit route, or route timing conditions for the transit route.

13. The computing system of claim 10, wherein the one or more factors comprise information that is external to the operation.

14. The computing system of claim 13, wherein the one or more factors comprise at least one of weather conditions, road conditions, or traffic light timing.

15. The computing system of claim 10, wherein identifying the set of driving behavior patterns correlated to the one or more factors comprises referencing a maintained mapping of driving behavior patterns to factors.

16. The computing system of claim 10, wherein the request for optimization of at least one operation related to the fleet of electric vehicles comprises a request to identify training to be performed by at least a portion of the plurality of drivers.

17. The computing system of claim 10, wherein the request for optimization of at least one operation related to the fleet of electric vehicles comprises a request to assign drivers to transit routes that are serviced by the fleet of electric vehicles.

18. A non-transitory computer-readable media collectively storing computer-executable instructions that upon execution cause one or more computing devices to collectively perform acts comprising:
maintaining, in relation to a plurality of drivers, driving behavior patterns determined to be associated with the each of the plurality of drivers;
receiving a request for determination of at least one operation related to a fleet of electric vehicles;
determining one or more factors associated with the optimization of the at least one operation;
identifying a set of driving behavior patterns correlated to the one or more factors; and
customizing the at least one operation based on the identified set of behavior patterns and the driving behavior patterns.

19. The non-transitory computer-readable media of claim 18, wherein the at least one driver assignment is generated by ranking each driver with respect to the at least one operation.

20. The non-transitory computer-readable media of claim 19, wherein the ranking indicates a suitability of the driver with respect to the at least one operation.
